(19) United States
(12) Patent Application Publication
(10) Pub. No.: US 2025/0310838 A1
(43) Pub. Date: Oct. 2, 2025

(54) METHODS AND APPARATUSES FOR SWITCHING TO A RELAY UE IN AN RRC IDLE OR INACTIVE STATE

(71) Applicant: LENOVO (BEIJING) LIMITED, Beijing (CN)

(72) Inventors: Lianhai WU, Beijing (CN); Jing HAN, Beijing (CN); Ran YUE, Beijing (CN); Haiming WANG, Beijing (CN); Jie HU, Beijing (CN)

(21) Appl. No.: 18/854,840

(22) PCT Filed: Apr. 8, 2022
(86) PCT No.: PCT/CN2022/085843

§ 371 Date: Oct. 7, 2024

(51) Int. Cl. H04W 36/00; H04W 76/27; H04W 88/04

(52) U.S. Cl. CPC H04W 36/0064; H04W 76/27; H04W 88/04

(57) ABSTRACT

Embodiments of the present application relate to methods and apparatuses for switching to a relay user equipment (UE) in a radio resource control (RRC) idle or inactive state. According to an embodiment of the present application, a target network node includes a transceiver and a processor coupled to the transceiver; and the processor is configured: to receive a handover request message via the transceiver from a source network node, wherein the handover request message includes identifier (ID) information of a candidate relay user equipment (UE) for a UE; and to transmit a response message via the transceiver to the source network node, wherein the response message includes at least one of: a handover request acknowledge message including ID information of a target relay UE for the UE; or a message to cancel a resource preparation of path switching for the UE.

### TECHNICAL FIELD

Embodiments of the present application generally relate to wireless communication technology, in particular to methods and apparatuses for switching to a relay user equipment (UE) in a radio resource control (RRC) idle or inactive state.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12, and enables a direct communication between proximal UEs, and data does not need to go through a base station (BS) or a core network.

In the 3rd Generation Partnership Project (3GPP), deployment of a relay node (RN) in a wireless communication system is promoted. One objective of deploying a RN is to enhance the coverage area of a BS by improving the throughput of a UE that is located in the coverage or far from the BS, which can result in relatively low signal quality. A RN may also be named as a relay UE in some cases. A 3GPP 5G sidelink system including a relay UE may be named as a sidelink relay system. A U2N relay UE is a UE that provides functionality to support connectivity to the network for U2N remote UE(s).

A UE may be in an RRC connected state, an RRC idle state, or an RRC inactive state. An RRC connected state may also be named as “a connected state” or “an RRC CONNECTED state” or the like. An RRC idle state may also be named as “an idle state” or “an RRC_IDLE state” or the like. An RRC inactive state may also be named as “an inactive state” or “an RRC_INACTIVE state” or the like.

Currently, in a wireless communication system or the like, details regarding how to switch to a relay UE in an RRC idle state or an RRC inactive state have not been specifically discussed yet.

### SUMMARY

Some embodiments of the present application provide a target network node (e.g., a target base station (BS)). The target network node includes a transceiver and a processor coupled to the transceiver; and the processor is configured: to receive a handover request message via the transceiver from a source network node, wherein the handover request message includes identifier (ID) information of a candidate relay user equipment (UE) for a UE; and to transmit a response message via the transceiver to the source network node, wherein the response message includes at least one of: a handover request acknowledge message including ID information of a target relay UE for the UE; or a message to cancel a resource preparation of path switching for the UE.

In some embodiments, the handover request acknowledge message further includes an RRC state of the target relay UE.

In some embodiments, the RRC state of the target relay UE is an RRC connected state or an RRC non-connected state.

In some embodiments, the message to cancel the resource preparation of path switching for the UE is a handover preparation failure message.

In some embodiments, the message to cancel the resource preparation of path switching for the UE includes a failure cause associated with the target relay UE.

In some embodiments, the failure cause includes at least one of: the target relay UE being high load; the target relay UE being overloaded; the target relay UE being not reached; or the target relay UE being not found.

In some embodiments, the processor of the target network node is configured: to determine whether the target relay UE is in an RRC connected state or an RRC non-connected state; and to transmit a paging message to the target relay UE, in response to determining that the target relay UE is in the RRC non-connected state.

In some embodiments, the RRC non-connected state includes at least one of an RRC idle state or an RRC inactive state.

In some embodiments, to transmit the response message, the processor of the target network node is configured: to transmit the handover request acknowledge message via the transceiver to the source network node before transiting the target relay UE to the RRC connected state; and to transmit the message to cancel the resource preparation of path switching for the UE via the transceiver to the source network node, in response to failing to reaching the target relay UE by the paging message.

In some embodiments, to transmit the response message, the processor of the target network node is configured: to transmit the handover request acknowledge message to the source network node, in response to the target relay UE entering into an RRC connected state after a reception of the paging message.

In some embodiments, to transmit the paging message, the processor of the target network node is configured: to transmit a first message for transiting the target relay UE from the RRC non-connected state to the RRC connected state via the transceiver to an access and mobility management function (AMF), in response to determining that the target relay UE is in the RRC non-connected state; and to receive a second message for triggering a radio access network (RAN) paging operation via the transceiver from the AMF; and to transmit the paging message to the target relay UE.

In some embodiments, the first message includes at least one of: the ID information of the target relay UE; or a request to transit the target relay UE from the RRC non-connected state to the RRC connected state.

In some embodiments, the ID information of the target relay UE is a source Layer-2 ID.

In some embodiments, the second message includes access stratum (AS) layer ID information of the target relay UE.

In some embodiments, the AS layer ID information of the target relay UE is: a NG-5G-S-temporary mobile subscriber identity (TMSI).

In some embodiments, a first association between a source Layer-2 ID of the target relay UE and AS layer ID information of the target relay UE is maintained in the AMF.

In some embodiments, the AS layer ID information of the target relay UE is identified by the AMF based on the source Layer-2 ID of the target relay UE and the first association.

In some embodiments, to transmit the paging message, the processor of the target network node is configured: to transmit a third message for transiting the target relay UE from the RRC non-connected state to the RRC connected state via the transceiver to a set of neighbour network nodes, in response to determining that the target relay UE is in the RRC non-connected state; and to receive a fourth message for triggering a radio access network (RAN) paging operation via the transceiver from a last serving network node of the UE, wherein the set of neighbour network nodes includes the last serving network node; and to transmit a paging message to the target relay UE. The last serving network node may be the last serving gNB, which configures the connected UE to an inactive state. The last serving gNB will keep the context of the UE.

In some embodiments, the third message includes at least one of: the ID information of the target relay UE; or a request to transit the target relay UE from the RRC non-connected state to the RRC connected state.

In some embodiments, the ID information of the target relay UE is a source Layer-2 ID.

In some embodiments, at least one of the fourth message or the paging message includes access stratum (AS) layer ID information of the target relay UE.

In some embodiments, the AS layer ID information of the target relay UE is an inactive radio network temporary identifier (I-RNTI) or a short I-RNTI.

In some embodiments, in response to the fourth message including the AS layer ID information of the target relay UE, a second association between a source Layer-2 ID of the target relay UE and the AS layer ID information of the target relay UE is maintained in the last serving network node.

In some embodiments, the AS layer ID information of the target relay UE is identified by the last serving network node based on the source Layer-2 ID of the target relay UE and the second association.

In some embodiments, in response to the fourth message not including the AS layer ID information of the target relay UE, the processor of the target network node is configured: to maintain a third association between the source Layer-2 ID of the target relay UE and the AS layer ID information of the target relay UE; and to identify the AS layer ID information of the target relay UE based on the source Layer-2 ID of the target relay UE and the third association.

In some embodiments, the paging message includes: a source Layer-2 ID of the target relay UE, or access stratum (AS) layer ID information of the target relay UE.

In some embodiments, the AS layer ID information of the target relay UE is: a NG-5G-S-temporary mobile subscriber identity (TMSI), or an inactive radio network temporary identifier (I-RNTI).

In some embodiments, to transmit the paging message including the AS layer ID information of the target relay UE, the processor of the target network node is configured: to maintain a fourth association between the source Layer-2 ID of the target relay UE and the AS layer ID information of the target relay UE; and to identify the AS layer ID information of the target relay UE on its own based on the source Layer-2 ID of the target relay UE and the fourth association.

In some embodiments, the processor of the target network node is configured to receive the source Layer-2 ID of the target relay UE via the transceiver from a serving cell of the target relay UE.

Some embodiments of the present application provide a method, which may be performed by a target network node (e.g., a target BS). The method includes: receiving a handover request message from a source network node, wherein the handover request message includes identifier (ID) information of a candidate relay user equipment (UE) for a UE; and transmitting a response message to the source network node, wherein the response message includes at least one of: a handover request acknowledge message including ID information of a target relay UE for the UE; or a message to cancel a resource preparation of path switching for the UE.

Some embodiments of the present application provide an access and mobility management function (AMF). The AMF includes a transceiver and a processor coupled to the transceiver; and the processor is configured: to receive a first message for transiting a target relay user equipment (UE) from a radio resource control (RRC) non-connected state to an RRC connected state via the transceiver from a target network node; and to transmit a second message for triggering a radio access network (RAN) paging operation to the target relay UE via the transceiver to the target network node.

In some embodiments, the RRC non-connected state includes at least one of an RRC idle state or an RRC inactive state.

In some embodiments, the first message includes at least one of: identifier (ID) information of the target relay UE; or a request to transit the target relay UE from the RRC non-connected state to the RRC connected state.

In some embodiments, the ID information of the target relay UE is a source Layer-2 ID.

In some embodiments, the second message includes access stratum (AS) layer ID information of the target relay UE.

In some embodiments, the AS layer ID information of the target relay UE is: a NG-5G-S-temporary mobile subscriber identity (TMSI).

In some embodiments, the processor of the AMF is configured: to maintain an association between a source Layer-2 ID of the target relay UE and AS layer ID information of the target relay UE; and to identify the AS layer ID information of the target relay UE based on the source Layer-2 ID of the target relay UE and the association.

In some embodiments, the processor of the AMF is configured to receive the source Layer-2 ID of the target relay UE via the transceiver from a serving cell of the target relay UE.

Some embodiments of the present application provide a method, which may be performed by an AMF. The method includes: receiving a message for transiting a target relay user equipment (UE) from a radio resource control (RRC) non-connected state to an RRC connected state from a target network node; and transmitting a message for triggering a radio access network (RAN) paging operation to the target relay UE to the target network node.

Some embodiments of the present application provide a last serving network node of a user equipment (UE). The last serving network node of the UE includes a transceiver and a processor coupled to the transceiver; and the processor is configured: to receive a third message for transiting a target relay user equipment (UE) from a radio resource control (RRC) non-connected state to an RRC connected state via the transceiver from a target network node; and to transmit a fourth message for triggering a radio access network (RAN) paging operation to the target relay UE via the transceiver to the target network node.

In some embodiments, the third message includes at least one of: the ID information of the target relay UE; or a request to transit the target relay UE from the RRC non-connected state to the RRC connected state.

In some embodiments, the ID information of the target relay UE is a source Layer-2 ID.

In some embodiments, the fourth message includes access stratum (AS) layer ID information of the target relay UE.

In some embodiments, the AS layer ID information of the target relay UE is an inactive radio network temporary identifier (I-RNTI) or a short I-RNTI.

In some embodiments, in response to the fourth message including the AS layer ID information of the target relay UE, the processor of the last serving network node is configured: to maintain a first association between a source Layer-2 ID of the target relay UE and the AS layer ID information of the target relay UE; and to identify the AS layer ID information of the target relay UE based on the source Layer-2 ID of the target relay UE and the first association.

In some embodiments, in response to the fourth message not including the AS layer ID information of the target relay UE, a second association between a source Layer-2 ID of the target relay UE and the AS layer ID information of the target relay UE is maintained in the target network node; and the AS layer ID information of the target relay UE is identified by the target network node based on the source Layer-2 ID of the target relay UE and the second association.

Some embodiments of the present application provide a method, which may be performed by a last serving network node of a user equipment (UE). The method includes: receiving a message for transiting a target relay user equipment (UE) from a radio resource control (RRC) non-connected state to an RRC connected state from a target network node; and transmitting a message for triggering a radio access network (RAN) paging operation to the target relay UE to the target network node.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a network node (e.g., a target BS), and an AMF, or a last serving network node of a UE.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary flow chart for receiving a handover request message in accordance with some embodiments of the present application.

FIG. 3 illustrates an exemplary flow chart for transmitting a message for triggering a RAN paging operation in accordance with some embodiments of the present application.

FIG. 4 illustrates a further exemplary flow chart for transmitting a message for triggering a RAN paging operation in accordance with some embodiments of the present application.

FIG. 5 illustrates a flow chart of an exemplary procedure of wireless communications in accordance with some embodiments of the present application.

FIG. 6 illustrates a flow chart of an exemplary procedure of wireless communications in accordance with some embodiments of the present application.

FIG. 7 illustrates a flow chart of an exemplary procedure of wireless communications in accordance with some embodiments of the present disclosure.

FIG. 8 illustrates a flow chart of an exemplary procedure of wireless communications in accordance with some embodiments of the present disclosure.

FIG. 9 illustrates an exemplary block diagram of an apparatus for a L2 U2N relay case in accordance with some embodiments of the present application.

FIG. 10 illustrates a further exemplary block diagram of an apparatus for a L2 U2N relay case in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates a schematic diagram of a wireless communication system 100 in accordance with some embodiments of the present application. As shown in FIG. 1, the wireless communication system 100 includes UE 101, BS 102, and relay UE 103 for illustrative purpose. Although a specific number of UE(s), relay UE(s), and BS(s) are depicted in FIG. 1, it is contemplated that any number of UE(s), relay UE(s), and BS(s) may be included in the wireless communication system 100.

Due to a far distance between UE 101 and BS 102, these they communicate with each other via relay UE 103. UE 101 may be connected to relay UE 103 via a network interface, for example, a PC5 interface as specified in 3GPP standard documents. Relay UE 103 may be connected to BS 102 via a network interface, for example, a Uu interface as specified in 3GPP standard documents. Referring to FIG. 1, UE 101 is connected to relay UE 103 via a PC5 link, and relay UE 103 is connected to BS 102 via a Uu link. UE 101 may be a U2N remote UE. Relay UE 103 may be a U2N relay UE, which is a UE that provides functionality to support connectivity to the network for U2N remote UE(s).

In some embodiments of the present application, UE 101 or relay UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

In some further embodiments of the present application, UE 101 or relay UE 103 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101 or relay UE 103 may include wearable devices, such as smart watches, fitness bands, optical head-mounted displays, or the like. Moreover, UE 101 or relay UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

BS(s) 102 may be distributed over a geographic region. In certain embodiments of the present application, each of the BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the downlink (DL), and UE(s) 101 (e.g., UE 101 or other similar UE) transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 1002.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

UE(s) 101 may access BS(s) 102 to receive data packets from BS(s) 102 via a downlink channel and/or transmit data packets to BS(s) 102 via an uplink channel. In normal operation, since UE(s) 101 does not know when BS(s) 102 will transmit data packets to it, UE(s) 101 has to be awake all the time to monitor the downlink channel (e.g., a Physical Downlink Control Channel (PDCCH)) to get ready for receiving data packets from BS(s) 102. However, if UE(s) 101 keeps monitoring the downlink channel all the time even when there is no traffic between BS(s) 102 and UE(s) 101, it would result in significant power waste, which is problematic to a power limited UE or a power sensitive UE.

Some embodiments of the present application refer to switching from direct to indirect path. A gNB (e.g., BS 102 as shown in FIG. 1) can select a U2N Relay UE (e.g., relay UE 103 as shown in FIG. 1) in any RRC state, i.e., RRC_IDLE, RRC_INACTIVE, or RRC_CONNECTED, as a target U2N Relay UE for direct to indirect path switch. For service continuity of L2 U2N Remote UE, the following procedure is used, in case of a L2 U2N Remote UE (e.g., UE 101 as shown in FIG. 1) switching to an indirect path via the U2N Relay UE in RRC_CONNECTED.
(1) Step 1: The U2N Remote UE reports one or multiple candidate U2N Relay UE(s) and Uu measurements, after it measures or discovers the candidate U2N Relay UE(s) (e.g., relay UE 103 as shown in FIG. 1).
(2) Step 2: The gNB decides to switch the U2N Remote UE to a target U2N Relay UE. Then the gNB sends an RRCReconfiguration message to the target U2N Relay UE, which can include at least Remote UE's local ID and source Layer-2 ID, Uu and PC5 Relay RLC channel configuration for relaying, and bearer mapping configuration.
(3) Step 3: The gNB sends the RRCReconfiguration message to the U2N Remote UE. The contents in the RRCReconfiguration message can include at least U2N Relay UE ID, PC5 Relay RLC channel configuration for relay traffic and the associated end-to-end radio bearer(s).
(4) Step 4: The U2N Remote UE establishes a PC5 connection with target U2N Relay UE.
(5) Step 5: The U2N Remote UE completes the path switch procedure by sending the RRCReconfigurationComplete message to the gNB via the Relay UE.
(6) Step 6: The data path is switched from direct path to indirect path between the U2N Remote UE and the gNB.

Embodiments of the present application aim to solve issues of an inter-gNB path switching in a L2 U2N relay case, e.g., in a use case of switching an inter-gNB direct or indirect path to an indirect path. For example, some embodiments of the present application study a mechanism for a case in which a remote UE is switched to a relay UE in an RRC idle or inactive state. Some embodiments of the present application study a case that a BS does not transit a relay UE in an RRC idle or inactive state to an RRC connected state before transmitting a handover request acknowledge message. Some further embodiments of the present application study a case that a BS does not transit a relay UE in an RRC idle or inactive state to an RRC connected state before transmitting a handover request acknowledge message, but the BS may transit the relay UE in an RRC idle or inactive state to an RRC connected state before a UE performs a path switching procedure. Some other embodiments of the present application study a case that a BS transits a relay UE in an RRC idle or inactive state to an RRC connected state before transmitting a handover request acknowledge message.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

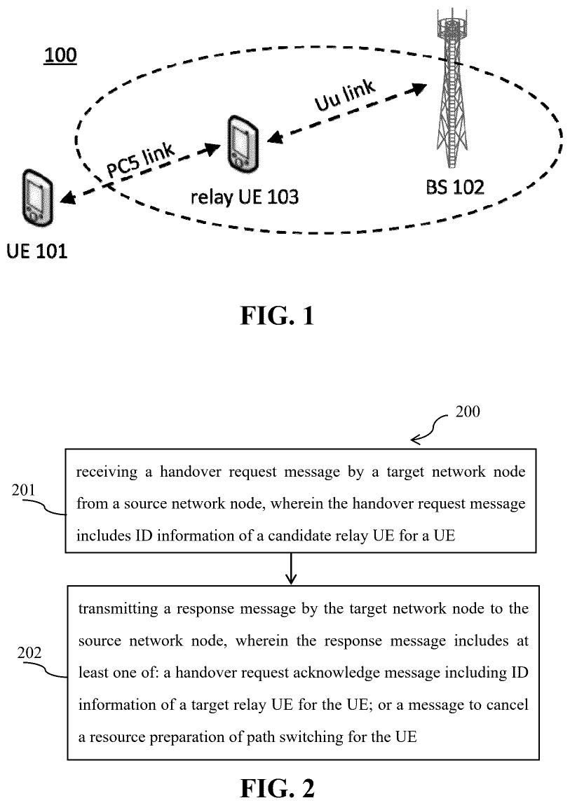

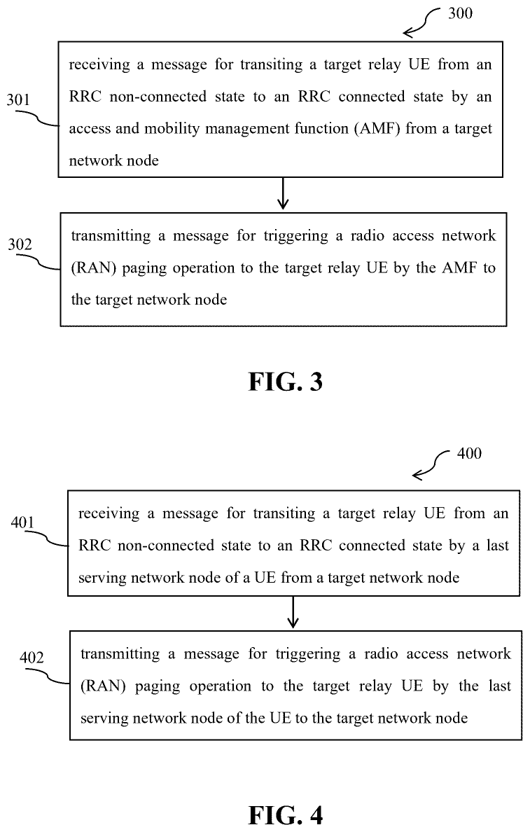

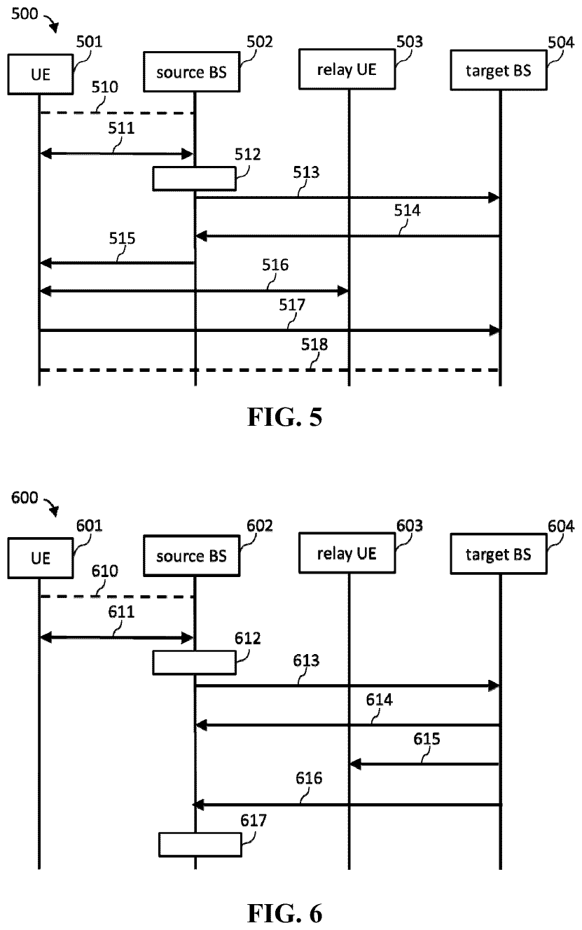

FIG. 2 illustrates an exemplary flow chart for receiving a handover request message in accordance with some embodiments of the present application. The exemplary flow chart 200 may be performed by a target network node (e.g., a target BS). Specific examples of exemplary flow chart 200 are described in embodiments of FIGS. 5-8 as follows. Although described with respect to a target network node, it should be understood that other devices may be configured to perform a method similar to that of FIG. 2. Details described in all other embodiments of the present application (for example, all details regarding switching to a relay UE in an RRC idle or inactive state) are applicable for the exemplary flow chart 200. Moreover, details described in the exemplary flow chart 200 are applicable for all the embodiments of FIGS. 3-10.

In the exemplary flow chart 200 as shown in FIG. 2, in operation 201, a target network node (e.g., target BS 504, target BS 604, target BS 704, or target BS 804 as shown in any of FIGS. 5-8) receives a handover request message from a source network node (e.g., source BS 502, source BS 602, source BS 702, or source BS 902 as shown in any of FIGS. 5-8). The handover request message includes ID information of a candidate relay UE for a UE (e.g., UE 501, UE 601, UE 701, or UE 801 as shown in any of FIGS. 5-8). In operation 202, the target network node transmits a response message to the source network node. The response message includes at least one of: a handover request acknowledge message including ID information of a target relay UE (e.g., relay UE 503, relay UE 603, relay UE 703, or relay UE 803 as shown in any of FIGS. 5-8) for the UE; or a message to cancel a resource preparation of path switching for the UE.

In some embodiments, the handover request acknowledge message further includes an RRC state of the target relay UE (e.g., relay UE 503, relay UE 603, relay UE 703, or relay UE 803 as shown in any of FIGS. 5-8). In an embodiment, the RRC state of the target relay UE is an RRC connected state or an RRC non-connected state. For example, the RRC non-connected state may include an RRC idle state and/or an RRC inactive state.

In some embodiments, the message to cancel the resource preparation is a handover preparation failure message. In an embodiment, the message to cancel the resource preparation includes a failure cause associated with the target relay UE. For example, the failure cause includes at least one of: the target relay UE being high load; the target relay UE being overloaded; the target relay UE being not reached; or the target relay UE being not found. A specific example is described in the embodiments of FIG. 6 as follows.

In some embodiments, the target network node determines whether the target relay UE is in an RRC connected state or an RRC non-connected state; and transmits a paging message to the target relay UE, in response to determining that the target relay UE is in the RRC non-connected state. In an embodiment, the RRC non-connected state includes an RRC idle state and/or an RRC inactive state. Specific examples are described in the embodiments of FIGS. 6-8 as follows.

In some embodiments, the target network node transmits the handover request acknowledge message to the source network node before transiting the target relay UE to the RRC connected state; and transmits the message to cancel the resource preparation to the source network node, in response to failing to reaching the target relay UE by the paging message. A specific example is described in the embodiments of FIG. 6 as follows.

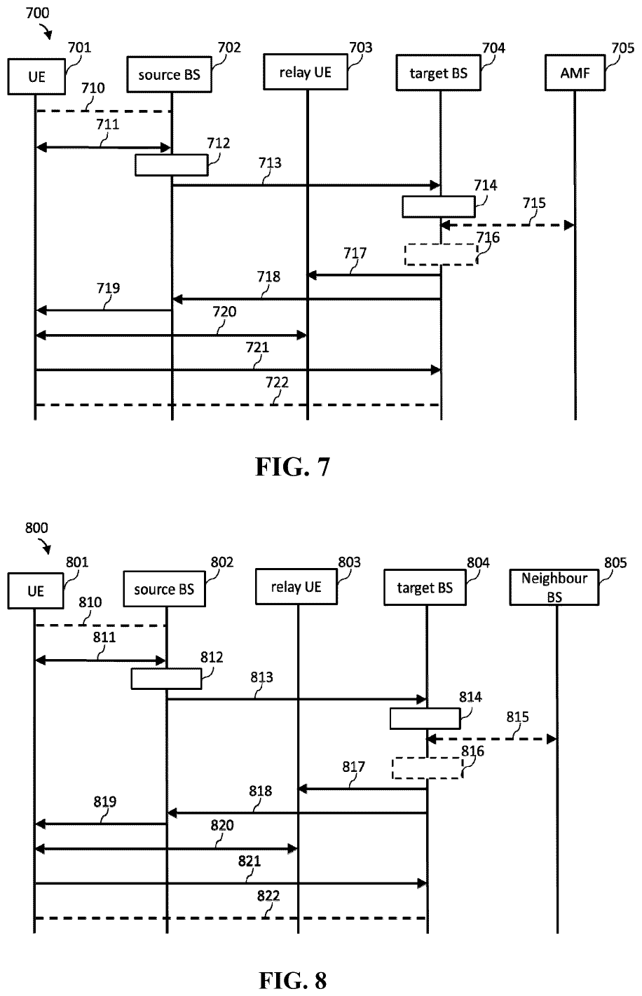

In some embodiments, the target network node transmits the handover request acknowledge message to the source network node, in response to the target relay UE entering into an RRC connected state after a reception of the paging message. Specific examples are described in the embodiments of FIGS. 7 and 8 as follows.

In some embodiments, the target network node transmits “a message (named as “1st message” for simplicity) for transiting the target relay UE from the RRC non-connected state to the RRC connected state” to an AMF (e.g., AMF 705 as shown in FIG. 7), in response to determining that the target relay UE is in the RRC non-connected state. The target network node receives “a message (named as “2nd message” for simplicity) for triggering a RAN paging operation” from the AMF. Then, the target network node transmits the paging message to the target relay UE. A specific example is described in the embodiments of FIG. 7 as follows.

In an embodiment, the 1st message includes: the ID information of the target relay UE; and/or a request to transit the target relay UE from the RRC non-connected state to the RRC connected state. For instance, the ID information of the target relay UE is a source Layer-2 ID. In an embodiment, the 2nd message includes AS layer ID information of the target relay UE. For example, the AS layer ID information is a NG-5G-S-TMSI. In an embodiment, an association between “a source Layer-2 ID of the target relay UE” and “AS layer ID information of the target relay UE” is maintained in the AMF. For instance, the AS layer ID information of the target relay UE is identified by the AMF based on the source Layer-2 ID of the target relay UE and the association.

In some embodiments, the target network node transmits “a message (named as “3rd message” for simplicity) for transiting the target relay UE from the RRC non-connected state to the RRC connected state” to a set of neighbour network nodes, in response to determining that the target relay UE is in the RRC non-connected state. The target network node receives “a message (named as “4th message” for simplicity) for triggering a RAN paging operation” from a last serving network node of the UE. The set of neighbour network nodes includes the last serving network node of the UE. Then, the target network node transmits a paging message to the target relay UE. The last serving network node of the UE may be the last serving gNB, which configures the connected UE to an inactive state. The last serving gNB will keep the context of the UE. A specific example is described in the embodiments of FIG. 8 as follows.

In an embodiment, the 3rd message includes: the ID information of the target relay UE; and/or a request to transit the target relay UE from the RRC non-connected state to the RRC connected state. For instance, the ID information of the target relay UE is a source Layer-2 ID. In an embodiment, the 4th message and/or “the paging message transmitted by the target network node” includes AS layer ID information of the target relay UE. For instance, the AS layer ID information is an I-RNTI or a short I-RNTI. The information element (IE) “Short I-RNTI-Value” may be used to identify the suspended UE context of a UE in an RRC inactive state using fewer bits compared to the IE “I-RNTI-Value”.

In some embodiments, in response to the 4th message including the AS layer ID information of the target relay UE, an association between “a source Layer-2 ID of the target relay UE” and “AS layer ID information of the target relay UE” is maintained in the last serving network node of the UE. The AS layer ID information of the target relay UE may be identified by the last serving network node of the UE based on the source Layer-2 ID of the target relay UE and the association.

In some embodiments, in response to the 4th message not including the AS layer ID information of the target relay UE, the target network node maintains an association between “a source Layer-2 ID of the target relay UE” and “AS layer ID information of the target relay UE”; and identifies the AS layer ID information of the target relay UE based on the source Layer-2 ID of the target relay UE and the association.

In some embodiments, the paging message includes: a source Layer-2 ID of the target relay UE, or AS layer ID information of the target relay UE. For instance, the AS layer ID information is a NG-5G-S-TMSI or an I-RNTI.

In some embodiments, the target network node maintains an association between “a source Layer-2 ID of the target relay UE” and “AS layer ID information of the target relay UE”, and identifies the AS layer ID information of the target relay UE on its own based on the source Layer-2 ID of the target relay UE and the association.

In some embodiments, the target network node receives the source Layer-2 ID of the target relay UE from a serving cell of the target relay UE. Specific examples are described in the embodiments of FIGS. 7 and 8 as follows.

FIG. 3 illustrates an exemplary flow chart for transmitting a message for triggering a RAN paging operation in accordance with some embodiments of the present application. The exemplary flow chart 300 may be performed by an AMF. A specific example of exemplary flow chart 300 is described in embodiments of FIG. 7 as follows. Although described with respect to an AMF, it should be understood that other devices may be configured to perform a method similar to that of FIG. 3. Details described in all other embodiments of the present application are applicable for the exemplary flow chart 300. Moreover, details described in the exemplary flow chart 300 are applicable for all the embodiments of FIGS. 2 and 4-10.

In the exemplary flow chart 300 as shown in FIG. 3, in operation 301, an AMF (e.g., AMF 705 as shown in FIG. 7) receives “a message for transiting a target relay UE (e.g., relay UE 703 as shown in FIG. 7) from an RRC non-connected state to an RRC connected state” from a target network node (e.g., target BS 704 as shown in FIG. 7). In operation 302, the AMF transmits “a message for triggering a RAN paging operation to the target relay UE” to the target network node.

In some embodiments, the RRC non-connected state includes an RRC idle state and/or an RRC inactive state.

In some embodiments, the message for transiting the target relay UE includes: ID information of the target relay UE; and/or a request to transit the target relay UE from the RRC non-connected state to the RRC connected state. In an embodiment, the ID information of the target relay UE is a source Layer-2 ID.

In some embodiments, the message for triggering the RAN paging operation includes AS layer ID information of the target relay UE. In an embodiment, the AS layer ID information is a NG-5G-S-TMSI.

In some embodiments, the AMF maintains an association between “a source Layer-2 ID of the target relay UE” and “AS layer ID information of the target relay UE”, and identifies the AS layer ID information of the target relay UE based on the source Layer-2 ID of the target relay UE and the association.

In some embodiments, the AMF receives the source Layer-2 ID of the target relay UE from a serving cell of the target relay UE.

FIG. 4 illustrates a further exemplary flow chart for transmitting a message for triggering a RAN paging operation in accordance with some embodiments of the present application. The exemplary flow chart 400 may be performed by a last serving network node of a UE, i.e., a previous serving network node which served the UE before the UE switching to the current serving network node. The last serving network node may be the last serving gNB, which configures the connected UE to an inactive state. The last serving gNB will keep the context of the UE. A specific example of exemplary flow chart 400 is described in embodiments of FIG. 8 as follows. Although described with respect to a last serving network node of a UE, it should be understood that other devices may be configured to perform a method similar to that of FIG. 4. Details described in all other embodiments of the present application are applicable for the exemplary flow chart 400. Moreover, details described in the exemplary flow chart 400 are applicable for all the embodiments of FIGS. 2, 3, and 5-10.

In the exemplary flow chart 400 as shown in FIG. 4, in operation 401, a last serving network node (e.g., neighbour BS 805 as shown in FIG. 8) of a UE (e.g., UE 801 as shown in FIG. 8) receives “a message for transiting a target relay UE (e.g., relay UE 803 as shown in FIG. 8) from an RRC non-connected state to an RRC connected state” from a target network node (e.g., target BS 804 as shown in FIG. 8). In operation 402, the last serving network node of the UE transmits “a message for triggering a RAN paging operation to the target relay UE” to the target network node.

In some embodiments, the message for transiting the target relay UE includes: the ID information of the target relay UE; and/or a request to transit the target relay UE from the RRC non-connected state to the RRC connected state. In an embodiment, the ID information of the target relay UE is a source Layer-2 ID.

In some embodiments, the message for triggering the RAN paging operation includes AS layer ID information of the target relay UE. In an embodiment, the AS layer ID information of the target relay UE is an I-RNTI or a short I-RNTI.

In some embodiments, in response to the message for triggering the RAN paging operation including the AS layer ID information of the target relay UE, the last serving network node maintains an association between “a source Layer-2 ID of the target relay UE” and “AS layer ID information of the target relay UE”, and identifies the AS layer ID information of the target relay UE based on the source Layer-2 ID of the target relay UE and the association.

In some embodiments, in response to the message for triggering the RAN paging operation not including the AS layer ID information of the target relay UE, an association between “a source Layer-2 ID of the target relay UE” and “AS layer ID information of the target relay UE” is maintained in the target network node; and the AS layer ID information of the target relay UE is identified by the target network node based on the source Layer-2 ID of the target relay UE and the association.

FIG. 5 illustrates a flow chart of an exemplary procedure 500 of wireless communications in accordance with some embodiments of the present disclosure. The exemplary procedure 500 refers to a procedure for Inter-gNB path switching from a direct or indirect path to an indirect path. In the exemplary procedure 500, a BS does not transit a relay UE in an RRC idle or inactive state to an RRC connected state before transmitting a handover request acknowledge message. Details described in all other embodiments of the present disclosure are applicable for the embodiments shown in FIG. 5.

Referring to FIG. 5, UE 501, target BS 504, and relay UE 503 may function as UE 101, BS 102, and relay UE 103 as shown in FIG. 1, respectively. Source BS 502 may be one source BS not shown in FIG. 1. In particular, following steps are performed in the exemplary procedure 500.
(1) Step 510: UE 501 accesses the serving BS, e.g., source BS 502, via a direct path or an indirect path between UE 501 and source BS 502. UE 501 stays at an RRC connected state. A UL or DL data transmission can be performed between UE 501 and source BS 502.
(2) Step 511: The measurement configuration and measurement report signalling procedures are performed between UE 501 and source BS 502 to evaluate both relay link measurement and Uu link measurement.
   a) For instance, UE 501 may report measurement result(s) based on configuration(s) received from source BS 502. In a case of the direct path between UE 501 and source BS 502, the measurement result(s) may include measurement result(s) for a cell or a candidate relay UE. In a case of the indirect path between UE 501 and source BS 502 via a relay UE (not shown in FIG. 5, e.g., relay UE #1), the measurement result(s) may include: a cell ID of a cell serving this relay UE (e.g., relay UE #1); a source layer-2 ID; and a measurement result of this relay UE (e.g., relay UE #1), e.g., reference signal received power (RSRP).
   b) For instance, UE 501 may report capability information to source BS 502. In some embodiments, the capability information includes at least one of:
      1) whether UE 501 can support path switching to a relay UE with an RRC idle or inactive state;
      2) a maximum number of candidate relay UE(s);
      3) a maximum number of candidate relay UE(s) per one target cell;
      4) a maximum number of candidate relay UE(s) with an RRC idle or inactive state; or
      5) a maximum number of candidate relay UE(s) with an RRC idle or inactive state per one target cell.
(3) Step 512: Source BS 502 decides to switch UE 501. For instance, source BS 502 may decide to switch UE 501 based on the measurement result(s). In one example, source BS 502 decides to switch UE 501 from “the direct path between UE 501 and source BS 502” to “an indirect path including a relay UE”. In a further example, source BS 502 decides to switch UE 501 from “the indirect path between UE 501 and source BS 502 via a relay UE (e.g., relay UE #1)” to “another indirect path including another relay UE”.
(4) Step 513: After the path switching decision in Step 512, source BS 502 transmits a handover request message to target BS 504.
   a) In an embodiment, ID information of candidate relay UE(s) is included in the handover request message.
   b) In an embodiment, ID information of a target cell (e.g., cell #1) of target BS 504 (e.g., Target Cell Global ID) is included in the handover request message.
   c) Source BS 502 may be not aware of a state of candidate relay UE(s). Optionally, in an embodiment, a preferred RRC state for a target relay UE can be included in the handover request message.
(5) Step 514: After target BS 504 receives the handover request message and admits the path switching, target BS 504 transmits a handover request acknowledge message to source BS 502 via Xn interface.
   a) In an embodiment, the handover request acknowledge message includes the ID information of target relay UE(s) (e.g., relay UE 503).
   b) In another embodiment, the handover request acknowledge message includes both the ID information of target relay UE(s) (e.g., relay UE 503) and ID information of the corresponding cell (e.g., cell #1) serving the target relay UE(s).
   c) In some embodiments, after target BS 504 receives the handover request message, target BS 504 can determine whether the candidate relay UE(s) is in a connected state or not.
   d) In some embodiments, an RRC state for target relay UE(s) is added in the handover request acknowledge message. The RRC state may be a connected state or a non-connected state. The non-connected state may be an idle state or an inactive state.
(6) Step 515: After source BS 502 receives the handover request acknowledge message, source BS 502 will transmit an RRC reconfiguration message including a path switching indication to UE 501.
   a) In some embodiments, the RRC state for target relay UE(s) is added in the path switching indication in the RRC reconfiguration message.
   b) In an embodiment, the handover request acknowledge message includes the ID information of the target relay UE(s) (e.g., relay UE 503).
   c) In another embodiment, the handover request acknowledge message includes both one the ID information of the target relay UE(s) (e.g., relay UE 503) and ID information of the corresponding cell (e.g., cell #1) serving the target relay UE(s).
(7) Step 516: After receiving the RRC reconfiguration message (including the path switching indication which includes the RRC state for target relay UE(s)), UE 501 executes a path switching procedure, to switch to an indirect path between UE 501 and source BS 502 via relay UE 503. In Step 516, UE 501 establishes a PC5 connection with relay UE 503.
   a) For instance, UE 501 may start a timer (e.g., timer #1) for path switching, upon a reception of the RRC reconfiguration message for path switching.
(8) Step 517: UE 501 transmits an RRC reconfiguration complete message to target BS 504 via relay UE 503.
   a) For instance, UE 501 may stop the timer (e.g., timer #1) for path switching, once UE 501 successfully transmits the RRC reconfiguration complete message (e.g., after receiving radio link control (RLC) feedback) to target BS 504 via relay UE 503.
(9) Step 518: After target BS 504 receives the RRC reconfiguration complete message, target BS 504 transmits a UE context release message to source BS 502. The UL or DL data transmission can be performed in Step 518.

FIG. 6 illustrates a flow chart of an exemplary procedure 600 of wireless communications in accordance with some embodiments of the present disclosure. The exemplary procedure 600 also refers to a procedure for Inter-gNB path switching from a direct or indirect path to an indirect path. In the exemplary procedure 600, a BS does not transit a relay UE in an RRC idle or inactive state to an RRC connected state before transmitting a handover request acknowledge message, but the BS may transit the relay UE in an RRC idle or inactive state to an RRC connected state before a UE performs a path switching procedure. Details described in all other embodiments of the present disclosure are applicable for the embodiments shown in FIG. 6.

Referring to FIG. 6, UE 601, target BS 604, and relay UE 603 may function as UE 101, BS 102, and relay UE 103 as shown in FIG. 1, respectively. Source BS 602 may be one source BS not shown in FIG. 1. In particular, following steps are performed in the exemplary procedure 600.
(1) Details of Step 610 to Step 613 are the same as those of Step 510 to Step 513 in exemplary procedure 500 as shown in FIG. 5, respectively.
(2) Step 614: After target BS 604 receives the handover request message and admits the path switching, target BS 604 transmits a handover request acknowledge message to source BS 602 via Xn interface.
   a) In an embodiment, the handover request acknowledge message includes ID information of target relay UE(s) (e.g., relay UE 603).
   b) In another embodiment, the handover request acknowledge message includes both the ID information of the target relay UE(s) (e.g., relay UE 603) and ID information of the corresponding cell (e.g., cell #1) serving the target relay UE(s).
(3) Step 615: After target BS 604 transmits the handover request acknowledge message, target BS 604 can determine whether the target relay UE(s) (e.g., relay UE 603) is in a connected state or not. If relay UE 603 is not in a connected state, target BS 604 transmits a paging message to relay UE 603.
(4) Step 616: if target BS 604 fails to reach relay UE 603 via the paging message in Step 615, target BS 604 will transmit “a message to cancel a resource preparation of path switching” to source BS 602.
   a) In some embodiments, the message to cancel the resource preparation is sent by target BS 604 to source BS 602 to cancel an already prepared path switching to relay UE 603.
   b) In an embodiment, the message to cancel the resource preparation is an existing message (e.g., a handover preparation failure message) or a new defined message.
   c) In an embodiment, the message to cancel the resource preparation includes a cancel cause associated with relay UE 603. The cancel cause could be: relay UE 603 is high load, relay UE 603 is overload, relay UE 603 is not reached, and/or relay UE 603 is not found.
(5) Step 617: After source BS 602 receives the message to cancel the resource preparation, source BS 602 will discard the received handover request acknowledge message for path switching to relay UE 603.

FIG. 7 illustrates a flow chart of an exemplary procedure 700 of wireless communications in accordance with some embodiments of the present disclosure. Exemplary procedure 700 also refers to a procedure for Inter-gNB path switching from a direct or indirect path to an indirect path. In the exemplary procedure 700, a BS transits a relay UE in an RRC idle state to an RRC connected state before transmitting a handover request acknowledge message. Details described in all other embodiments of the present disclosure are applicable for the embodiments shown in FIG. 7.

Referring to FIG. 7, UE 701, target BS 704, and relay UE 703 may function as UE 101, BS 102, and relay UE 103 as shown in FIG. 1, respectively. Source BS 702 may be one source BS not shown in FIG. 1. In particular, following steps are performed in the exemplary procedure 700.
(1) Details of Step 710 to Step 713 are the same as those of Step 510 to Step 513 in exemplary procedure 500 as shown in FIG. 5, respectively.
(2) Step 714: After target BS 704 receives the handover request message, target BS 704 determines whether target relay UE(s) (e.g., relay UE 703) is in a connected state or not. If target BS 704 determines that relay UE 703 is in an idle state, target BS 704 performs as follows.
   1) In some embodiments, target BS 704 obtains AS layer ID of relay UE 703, and then include the AS layer ID of relay UE 703 in a paging message to relay UE 703. There may be following two options in different embodiments, i.e., Option 1 and Option 2.
      a) Option 1: Step 715 is performed after Step 714. In Step 715, target BS 704 informs AMF 705 to transit relay UE 703 to a connected state via NG interface. Then, AMF 705 transmits information to target BS 704 to trigger a RAN paging operation. In some embodiments, target BS 704 transmits an ID of relay UE 703 and a request to transit the target relay UE from the RRC non-connected state to the RRC connected state. For instance, the ID of relay UE 803 transmitted by target BS 804 to AMF 705 is Source Layer-2 ID. AMF 705 identifies AS layer ID (e.g., NG-5G-S-TMSI) of relay UE 703 based on the received Source Layer-2 ID, and then transmits the AS layer ID of relay UE 703 to target BS 704. Regarding how to identify the AS layer ID, there may be following two options in different embodiments, i.e., Option A1 and Option A2.
         Option A1: AMF 705 maintains an association between AS layer ID and Source Layer-2 ID of a UE. AMF 705 may identify the AS layer ID of relay UE 703 based on the received Source Layer-2 ID and the maintained association, and then transmits the AS layer ID to target BS 704 in Step 715.
         In an embodiment, relay UE 703 reports its Source Layer-2 ID to a serving cell of target BS 704. Then, the serving cell can transfer the Source Layer-2 ID to AMF 705. After that, AMF 705 may maintain the association between AS layer ID and Source Layer-2 ID of relay UE 703.
         Option A2: AMF 705 transmits a request (e.g., including Source Layer-2 ID of relay UE 703) to V2X entity. V2X entity identifies the AS layer ID of relay UE 703 based on the received Source Layer-2 ID. After that, AMF 705 obtains the AS layer ID of relay UE 703 and then transmits the AS layer ID to target BS 704 in Step 715.
      b) Option 2: Step 716 is performed after Step 714. Target BS 704 itself identifies the AS layer ID (e.g., NG-5G-S-TMSI) of relay UE 703 based on the received Source Layer-2 ID.
         In some embodiments, target BS 704 maintains an association between AS layer ID (e.g., NG-5G-S-TMSI) and Source Layer-2 ID of a UE. Target BS 704 may identify AS layer ID (e.g., NG-5G-S-TMSI) of relay UE 703 based on the received Source Layer-2 ID of relay UE 703 and the maintained association.
         In an embodiment, relay UE 703 will report its Source Layer-2 ID to a serving cell serving relay UE 703. The serving cell serving relay UE 703 can transfer the Source Layer-2 ID to neighour BS(s), e.g., including target BS 704. Thus, target BS 704 may maintain the association between AS layer ID (e.g., NG-5G-S-TMSI) and Source Layer-2 ID of relay UE 703.
2) In some other embodiments, target BS 704 do not obtain the AS layer ID of relay UE 703 after Step 714 (not performing Step 715 or Step 716 which is optional as shown in FIG. 7), but may include the Source Layer-2 ID of relay UE 703 (which is received in the handover request message) in a paging message to relay UE 703.
(3) Step 717: target BS 704 transmits a paging message including the ID of relay UE 703 (e.g., Source Layer-2 ID, or NG-5G-S-TMSI) to relay UE 703. Once relay UE 703 receives the paging message, relay UE 703 performs a connection establishment procedure. Then, relay UE 703 enters into a connected state.
(4) Step 718: After relay UE 703 enters into the connected state, target BS 704 transmits a handover request acknowledge message to source BS 702 via Xn interface.
(5) Details of Step 719 to Step 722 are the same as those of Step 515 to Step 518 in exemplary procedure 500 as shown in FIG. 5, respectively.

FIG. 8 illustrates a flow chart of an exemplary procedure 800 of wireless communications in accordance with some embodiments of the present disclosure. Exemplary procedure 800 also refers to a procedure for Inter-gNB path switching from a direct or indirect path to an indirect path. In the exemplary procedure 800, a BS transits a relay UE in an RRC inactive state to an RRC connected state before transmitting a handover request acknowledge message. Details described in all other embodiments of the present disclosure are applicable for the embodiments shown in FIG. 8.

Referring to FIG. 8, UE 801, target BS 804, and relay UE 803 may function as UE 101, BS 102, and relay UE 103 as shown in FIG. 1, respectively. Source BS 802 may be one source BS not shown in FIG. 1. In particular, following steps are performed in the exemplary procedure 800.
(1) Details of Step 810 to Step 813 are the same as those of Step 510 to Step 513 in exemplary procedure 500 as shown in FIG. 5, respectively.
(2) Step 814: After target BS 804 receives the handover request message, target BS 804 determines whether target relay UE(s) (e.g., relay UE 803) is in a connected state or not. If target BS 804 determines that relay UE 803 is in an inactive state, target BS 804 performs as follows.
   1) In some embodiments, target BS 804 obtains AS layer ID of relay UE 803, and then include the AS layer ID of relay UE 803 in a paging message to relay UE 803. There may be following three options in different embodiments, i.e., Option A, Option B, and Option C.
      a) Option A: Step 815 is performed after Step 814. In Step 815, if target BS 804 does not maintain or store I-RNTI or ShortI-RNTI of relay UE 803, target BS 804 informs neighbour BS(s) (including the last serving BS of UE 801, i.e., neighbour BS 805 as shown in FIG. 8) to transit relay UE 803 to a connected state. Then, neighbour BS 805 transmits information to target BS 804 to trigger a RAN paging operation.
         In some embodiments, target BS 804 transmits an ID of relay UE 803 and a request to transit the target relay UE from the RRC non-connected state to the RRC connected state. For instance, the ID of relay UE 803 transmitted by target BS 804 to neighbour BS 805 is Source Layer-2 ID. Neighbour BS 805 can identify AS layer ID (e.g., I-RNTI or ShortI-RNTI) of relay UE 803 based on the received Source Layer-2 ID, and then transmits the AS layer ID to target BS 804 in Step 815.
         In an embodiment, neighbour BS 805 maintains an association between AS layer ID and Source Layer-2 ID of a UE. Neighbour BS 805 may identify AS layer ID of relay UE 703 (e.g., I-RNTI or ShortI-RNTI) based on the received Source Layer-2 ID and the maintained association, and then transmit the AS layer ID to target BS 804 in Step 815.
      a) Option B: Step 815 is performed after Step 814. In Step 815, if target BS 804 maintains or stores I-RNTI or ShortI-RNTI of relay UE 803, target BS 804 informs neighbour BS(s) (including the last serving BS of UE 801, i.e., neighbour BS 805) to transit relay UE 803 to a connected state. Then, neighbour BS 805 transmits information to target BS 804 to trigger a RAN paging operation.
         In an embodiment, target BS 804 maintains an association between AS layer ID (e.g., I-RNTI or ShortI-RNTI) and Source Layer-2 ID of a UE. Target BS 804 identifies AS layer ID of relay UE 803 based on the received Source Layer-2 ID of relay UE 803 in the handover request message and the maintained association.
         In an embodiment, a last serving BS of relay UE 803 transmits the association between “I-RNTI or ShortI-RNTI” and “Source Layer-2 ID” to neighbour BS(s) (including target BS 804) belonging to the same RAN notification area. Thus, target BS 804 may maintain the association and have I-RNTI or ShortI-RNTI of relay UE 803.
         In some embodiments, target BS 804 transmits an ID of relay UE 803 (e.g., I-RNTI or ShortI-RNTI) and a request to transit the target relay UE from the RRC non-connected state to the RRC connected state. Then, neighbour BS 805 transmits information to target BS 804 to trigger a RAN paging operation.
      b) Option C: Step 816 is performed after Step 814. In Step 816, target BS 804 itself identifies AS layer ID (e.g., I-RNTI or ShortI-RNTI) of relay UE 803, and then includes the AS layer ID in a paging message to relay UE 803.
         In an embodiment, target BS 804 maintains an association between AS layer ID (e.g., I-RNTI or ShortI-RNTI) and Source Layer-2 ID of a UE. Target BS 804 identifies AS layer ID of relay UE 803 based on the received Source Layer-2 ID of relay UE 803 in the handover request message and the maintained association.
         In an embodiment, a last serving BS of relay UE 803 transmits the association between “I-RNTI or ShortI-RNTI” and “Source Layer-2 ID” to neighbour BS(s) (including target BS 804) belonging to the same RAN notification area. Thus, target BS 804 may maintain the association and have I-RNTI or ShortI-RNTI of relay UE 803.
   2) In some other embodiments, target BS 804 do not obtain the AS layer ID (e.g., I-RNTI or ShortI-RNTI) of relay UE 803 after Step 814 (not performing Step 815 or Step 816 which is optional as shown in FIG. 8), but may include the Source Layer-2 ID of relay UE 803 (which is received in the handover request message) in a paging message to relay UE 803.
(3) Step 817: target BS 804 transmits a paging message including the ID of relay UE 803 (e.g., Source Layer-2 ID, I-RNTI, or ShortI-RNTI) to relay UE 803. Once relay UE 803 receives the paging message, relay UE 803 performs a connection resumption procedure. Then, relay UE 803 enters into a connected state.
(4) Step 818: After relay UE 803 enters into the connected state, target BS 804 transmits a handover request acknowledge message to source BS 802 via Xn interface.
(5) Details of Step 819 to Step 822 are the same as those of Step 515 to Step 518 in exemplary procedure 500 as shown in FIG. 5, respectively.

It should be appreciated by persons skilled in the art that the sequence of the operations in any of exemplary procedures 200 to 800 in FIGS. 2-8 may be changed and some of the operations in any of exemplary procedures 200 to 800 in FIGS. 2-8 may be eliminated or modified, without departing from the spirit and scope of the disclosure.

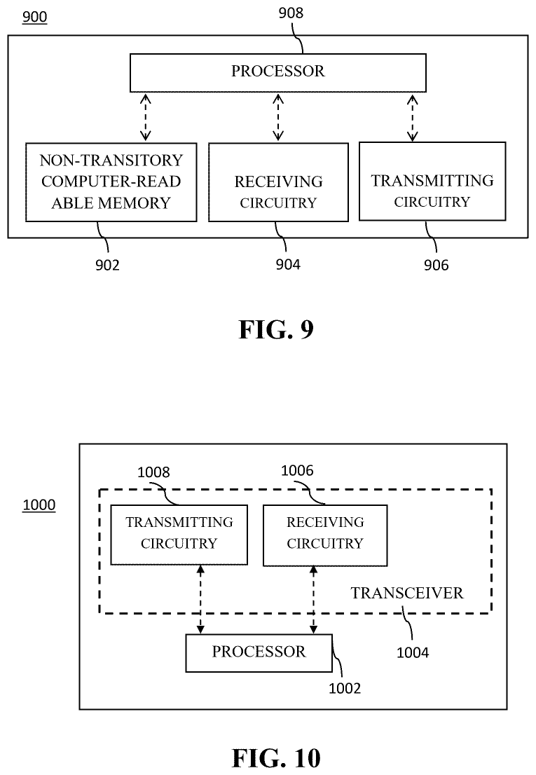

Some embodiments of the present application also provide a wireless communication apparatus for a L2 U2N relay case. For example, FIG. 9 illustrates an exemplary block diagram of an apparatus 900 for a L2 U2N relay case in accordance with some embodiments of the present application.

As shown in FIG. 9, the apparatus 900 may include at least one non-transitory computer-readable medium 902, at least one receiving circuitry 904, at least one transmitting circuitry 906, and at least one processor 908 coupled to the non-transitory computer-readable medium 902, the receiving circuitry 904 and the transmitting circuitry 906. The at least one processor 908 may be a CPU, a DSP, a microprocessor etc. The apparatus 900 may be a network apparatus (e.g., a target BS, an AMF, or a last serving BS of a UE) configured to perform a method illustrated in the above or the like.

Although in this figure, elements such as the at least one processor 908, receiving circuitry 904, and transmitting circuitry 906 are described in the singular, the plural is contemplated unless a limitation to the singular is explicitly stated. In some embodiments of the present application, the receiving circuitry 904 and the transmitting circuitry 906 can be combined into a single device, such as a transceiver. In certain embodiments of the present application, the apparatus 900 may further include an input device, a memory, and/or other components.

In some embodiments of the present application, the non-transitory computer-readable medium 902 may have stored thereon computer-executable instructions to cause a processor to implement the method with respect to a network apparatus (e.g., a target BS, an AMF, or a last serving BS of a UE) as described above. For example, the computer-executable instructions, when executed, cause the processor 908 interacting with receiving circuitry 904 and transmitting circuitry 906, so as to perform the steps with respect to a network apparatus (e.g., a target BS, an AMF, or a last serving BS of a UE) as illustrated above.

FIG. 10 illustrates a further exemplary block diagram of an apparatus 1000 for a L2 U2N relay case in accordance with some embodiments of the present application.

Referring to FIG. 10, the apparatus 1000, for example a BS or a UE, may include at least one processor 1002 and at least one transceiver 1004 coupled to the at least one processor 1002. The transceiver 1004 may include at least one separate receiving circuitry 1006 and transmitting circuitry 1008, or at least one integrated receiving circuitry 1006 and transmitting circuitry 1008. The at least one processor 1002 may be a CPU, a DSP, a microprocessor etc.

According to some embodiments of the present application, when the apparatus 1000 is a target BS, the processor 1002 is configured: to receive a handover request message via the transceiver from a source network node, wherein the handover request message includes ID information of a candidate relay UE for a UE; and to transmit a response message via the transceiver to the source network node, wherein the response message includes at least one of: a handover request acknowledge message including ID information of a target relay UE for the UE; or a message to cancel a resource preparation of path switching for the UE.

According to some embodiments of the present application, when the apparatus 1000 is an AMF, the processor 1002 is configured: to receive a message for transiting a target relay UE from an RRC non-connected state to an RRC connected state via the transceiver from a target network node; and to transmit a message for triggering a RAN paging operation to the target relay UE via the transceiver to the target network node.

According to some other embodiments of the present application, when the apparatus 1000 is a last serving network node of a UE, the processor 1002 is configured: to receive a message for transiting a target relay UE from an RRC non-connected state to an RRC connected state via the transceiver from a target network node; and to transmit a message for triggering a RAN paging operation to the target relay UE via the transceiver to the target network node.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”.

1. A target network node, comprising:
at least one memory; and
at least one processor coupled with the at least one memory and configured to cause the target network node to:
receive a handover request message from a source network node, wherein the handover request message includes identifier (ID) information of a candidate relay user equipment (UE) for a UE; and
transmit a response message to the source network node, wherein the response message includes at least one of:
a handover request acknowledge message including ID information of a target relay UE for the UE; or
a message to cancel a resource preparation of path switching for the UE.

2. The target network node of claim 1, wherein the handover request acknowledge message further includes a radio resource control (RRC) state of the target relay UE.

3. The target network node of claim 2, wherein the RRC state of the target relay UE is an RRC connected state or an RRC non-connected state.

4. The target network node of claim 1, wherein the message to cancel the resource preparation of path switching for the UE is a handover preparation failure message.

5. The target network node of claim 1, wherein the message to cancel the resource preparation of path switching for the UE includes a failure cause associated with the target relay UE.

6. The target network node of claim 5, wherein the failure cause includes at least one of:
the target relay UE being high load;
the target relay UE being overloaded;
the target relay UE being not reached; or
the target relay UE being not found.

7. The target network node of claim 1, wherein the at least one processor is further configured to cause the target network node to:
determine whether the target relay UE is in a radio resource control (RRC) connected state or an RRC non-connected state; and
transmit a paging message to the target relay UE, in response to determining that the target relay UE is in the RRC non-connected state.

8. The target network node of claim 3, wherein the RRC non-connected state includes at least one of an RRC idle state or an RRC inactive state.

9. The target network node of claim 7, wherein, to transmit the response message, the at least one processor is further configured to cause the target network node to:
transmit the handover request acknowledge message to the source network node before transiting the target relay UE to the RRC connected state; and
transmit the message to cancel the resource preparation of path switching for the UE via the transceiver to the source network node, in response to failing to reach the target relay UE by the paging message.

10. The target network node of claim 7, wherein, to transmit the response message, the at least one processor is configured to cause the target network node to:
transmit the handover request acknowledge message to the source network node, in response to the target relay UE entering into an RRC connected state after a reception of the paging message.

11. The target network node of claim 7, wherein, to transmit the paging message, the at least one processor is configured to cause the target network node to:
transmit a first message for transiting the target relay UE from the RRC non-connected state to the RRC connected state to an access and mobility management function (AMF), in response to determining that the target relay UE is in the RRC non-connected state;
receive a second message for triggering a radio access network (RAN) paging operation via the transceiver from the AMF; and
transmit the paging message to the target relay UE.

12. The target network node of claim 11, wherein the first message includes at least one of:
the ID information of the target relay UE; or
a request to transit the target relay UE from the RRC non-connected state to the RRC connected state.

13. The target network node of claim 12, wherein the ID information of the target relay UE is a source Layer-2 ID.

14. An access and mobility management function (AMF), comprising:
at least one memory; and
at least one processor coupled with the at least one memory and configured to cause the AMF to:
receive a first message for transiting a target relay user equipment (UE) from a radio resource control (RRC) non-connected state to an RRC connected state from a target network node; and
transmit a second message for triggering a radio access network (RAN) paging operation to the target relay UE to the target network node.

15. A last serving network node of a user equipment (UE), comprising:
at least one memory; and
at least one processor coupled with the at least one memory and configured to cause the last serving network node to:
receive a third message for transiting a target relay user equipment (UE) from a radio resource control (RRC) non-connected state to an RRC connected state from a target network node; and
transmit a fourth message for triggering a radio access network (RAN) paging operation to the target relay UE to the target network node.

16. A method performed by a target network node, the method comprising:
receiving a handover request message from a source network node, wherein the handover request message includes identifier (ID) information of a candidate relay user equipment (UE) for a UE; and
transmitting a response message to the source network node, wherein the response message includes at least one of:
a handover request acknowledge message including ID information of a target relay UE for the UE; or
a message to cancel a resource preparation of path switching for the UE.

17. The method of claim 16, wherein the handover request acknowledge message further includes a radio resource control (RRC) state of the target relay UE.

18. The method of claim 16, wherein the message to cancel the resource preparation of path switching for the UE includes a failure cause associated with the target relay UE.

19. The method of claim 16, further comprising:
determining whether the target relay UE is in a radio resource control (RRC) connected state or an RRC non-connected state; and
transmitting a paging message to the target relay UE, in response to determining that the target relay UE is in the RRC non-connected state.

20. The method of claim 19, wherein the RRC non-connected state includes at least one of an RRC idle state or an RRC inactive state.
